(19) United States
(12) Patent Application Publication
(10) Pub. No.: US 2008/0197815 A1
(43) Pub. Date: Aug. 21, 2008

(54) Vehicle electrical system having a reverse polarization detector

(76) Inventors: Steffen Liebstueckel, Ludwigsburg (DE); Herbert Labitzke, Markgroeningen (DE); Helmut Suelzle, Freiberg (DE)

Correspondence Address: KENYON & KENYON LLP, ONE BROADWAY, NEW YORK, NY, 10004, US

(21) Appl. No.: 12/011,266

(22) Filed: Jan. 24, 2008

(30) Foreign Application Priority Data
Jan. 24, 2007 (DE) 102007003545.6

(51) Int. Cl. H02P 9/00; H02J 7/00; G08B 21/00

(52) U.S. Cl. 322/5; 320/137; 340/664

(57) ABSTRACT

A vehicle electrical system includes an alternator, a rectifier connected to the alternator, a battery which is connectable to the output connections of the rectifier, and a reverse polarization detector connected to the battery. The reverse polarization detector includes a diode. In addition, the reverse polarization detector has a threshold-value element connected in series with the diode.

### BACKGROUND INFORMATION

German Patent Application No. DE 21 47 695 describes a battery charger having a reverse-polarity protection for vehicles. In this battery charger the positive terminal connector of the battery is directly connected to the positive terminal connector of the generator. The negative terminal connector of the generator is connected to ground, as is the negative terminal connector of the battery. If the battery in such a system is connected to the generator using the wrong polarity, there is the risk that a high short-circuit current will flow via the diodes provided to rectify the generator power output, thereby destroying them and possibly additional components of the system as well. To prevent this, at least one direct-current terminal connector of the generator is assigned a reverse-polarity protection device, which includes a fuse, which melts if the battery is connected to the direct-current terminal connectors of the generator with reverse polarization and which interrupts the short-circuit current. The fuse can be connected via a supplementary diode, so that even during the blow-out of the fuse no short-circuit current will run through the load-rectifier set.

German Patent No. DE 30 30 700 describes a battery-charge system, in which a reverse-polarization connection of the battery can be established irrefutably. This system includes an alternator, a rectifier connected downstream from the generator, a connectable battery, and a diode. To detect reverse polarization of the battery, the diode is connected parallel to the direct-voltage output of the generator in reverse direction, and its output dimensioned such that a reverse polarity connection of the battery will result in the immediate destruction of the diode.

### SUMMARY OF THE INVENTION

A vehicle electrical system according to the present invention has the advantage that filtering is implemented by the use of a threshold-value element in the sense that random interference is unable to elicit a response by the reverse-polarization detector. More specifically, the use of a threshold-value element suppresses low-energy voltage spikes and other inference that are not attributable to a reverse polarization.

Additional advantageous characteristics of a vehicle electrical system according to the present invention are that a reverse polarization during connection of the battery is detected and stored, so that this information is available later on and thereby makes it possible to reject unjustified customer claims with regard to warranty and reimbursement. Such unjustified customer demands are present, for instance, when an inspection reveals an interruption of the signal path in which the diode and the threshold-value element are situated. In another specific embodiment of the present invention, unwarranted customer claims may be identified based on the fact that the threshold-value element itself is destroyed in the particular signal path in which the diode and the threshold-value element are disposed.

According to an advantageous further development, a verification element, which in turn has a filter function, is connected in series with the diode and the threshold-value element. This increases the margin of safety with respect to an undesired triggering of the verification element and thus the entire reverse polarization detector.

### BRIEF DESCRIPTION OF THE DRAWINGS

FIG. 1 shows a first exemplary embodiment of a vehicle electrical system according to the present invention.

FIG. 2 shows a second exemplary embodiment of a vehicle electrical system according to the present invention.

FIG. 3 shows a third exemplary embodiment of a vehicle electrical system according to the present invention.

FIG. 4 shows a fourth exemplary embodiment of a vehicle electrical system according to the present invention.

FIG. 5 shows a fifth exemplary embodiment of a vehicle electrical system according to the present invention.

### DETAILED DESCRIPTION

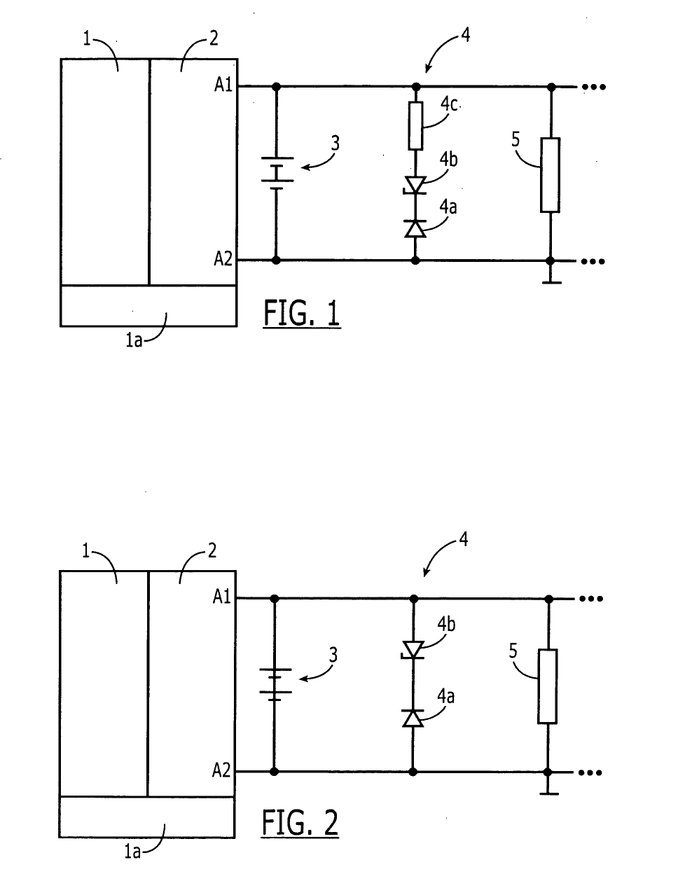

FIG. 1 shows a first exemplary embodiment of a vehicle electrical system according to the present invention. The illustrated vehicle electrical system includes an alternator 1, a rectifier 2, a generator controller 1a, a battery 3, a reverse polarization detector 4, and loads 5.

Rectifier 2 is provided to rectify the alternating current voltages generated by alternator 1, and it supplies a positive direct current at its output A1 and a ground signal at its output A2.

The positive direct current provided at output A1 of the rectifier is also applied at the positive pole of battery 3, at the ground-distal terminal of reverse polarization detector 4, and at the ground-distal terminal of loads 5. Output A2 of rectifier 2 is connected to the negative pole of battery 3, the other terminal of reverse polarization detector 4, and the other terminal of loads 5.

Reverse polarization detector 4 includes a verification element 4c, a threshold-value element 4b, and a diode 4a, and these elements are connected in series. Threshold-value element 4b is preferably realized in the form of a Zener diode. The anode of diode 4a is connected to output A2 of rectifier 2 and thus to ground as well. The cathode of diode 4a is connected to the cathode of Zener diode 4b. The anode of Zener diode 4b is connected to output A1 of rectifier 2 via verification element 4c. Verification element 4c, with whose aid it can later be demonstrated that a reverse polarization has taken place, is, for instance, a fuse, a bonding wire, a diode, a chemical indicator element, an optical indicator element, an appropriately dimensioned circuit trace on a circuit board or in an ASIC, a pyrotechnical element, a thermal element, or some other electric component.

During proper operation of the illustrated vehicle electrical system, diode 4a prevents a current flow through reverse polarization detector 4 since it is connected in reverse direction.

However, if a reverse polarization exists and if the negative voltage produced thereby is greater than the sum of the forward voltage of diode 4a and the Zener voltage of Zener diode 4b, then the verification path is enabled, and a current flows through verification element 4c, thereby triggering the verification element.

This verification element 4c is advantageously developed in such a way that it has a filter function. Verification element 4c may have a specified current carrying capacity, for example. Due to this special design of the verification element, the verification element, and thus the reverse polarization detector in its entirety, will not be triggered by random interference. Instead, especially interferences and low-energy voltages that are not attributable to a reverse polarization are filtered out or suppressed.

If a reverse polarization has occurred, then verification element 4c will be triggered, as mentioned earlier already. This state, which consists of an interruption of the verification path, for example, is stored and is therefore available later on as proof of a reverse polarization. This proof can be rendered by checking the detection path. This may possibly require a disconnection of additional electrical components. Diode 4a remains intact when verification element 4c is triggered.

In view of all this, the use of Zener diode 4b and the particular design of verification element 4c result in the detection of a negative voltage that is greater than a defined threshold value and is present for a defined minimum period of time, and in the storing of this event in an irreversible manner.

FIG. 2 shows a second exemplary embodiment of a vehicle electrical system according to the present invention. The difference between this second exemplary embodiment and the first exemplary embodiment shown in FIG. 1 is a modified design of reverse polarization detector 4. According to the second exemplary embodiment, it has a threshold-value element 4b and a diode 4a, these elements being connected in series. Here, too, threshold-value element 4b is preferably realized in the form of a Zener diode. The anode of diode 4a is connected to output A2 of rectifier 2 and thus to ground as well. The cathode of diode 4a is connected to the cathode of Zener diode 4b. The anode of Zener diode 4b is directly connected to output A1 of rectifier 2.

In this exemplary embodiment as well, diode 4a prevents a current flow through reverse polarization detector 4 during proper operation of the illustrated vehicle electrical system, since it is connected in reverse direction.

On the other hand, if reverse polarization is present and if the negative voltage produced thereby is greater than the sum of the forward voltage of diode 4a and the Zener voltage of Zener diode 4b, then the verification path is enabled. The current then flowing destroys Zener diode 4b.

In this specific embodiment, as well, the Zener diode influences the level of the negative voltage at which triggering takes place. Furthermore, the Zener diode may be designed to have a defined, low current carrying capacity. This specifies the energy required to trigger or destroy the Zener diode. It corresponds to a filter function of the Zener diode. Due to this filter function, triggering of reverse polarization detector 4 will not come about by random interference or random low-energy voltage.

If reverse polarization exists, then triggering of the reverse polarization detector takes place, as explained earlier already, and the Zener diode is destroyed in the process. Such a state is irreversible and thus is available as later proof of the existence of a reverse polarization. This proof may be rendered by showing the interruption of the detection path that has occurred and also the destruction of the Zener diode.

In view of all this, the use of the Zener diode and its design make it possible to detect a negative voltage that is greater than a defined threshold value and present for a defined minimum period of time, and to store this event in an irreversible manner.

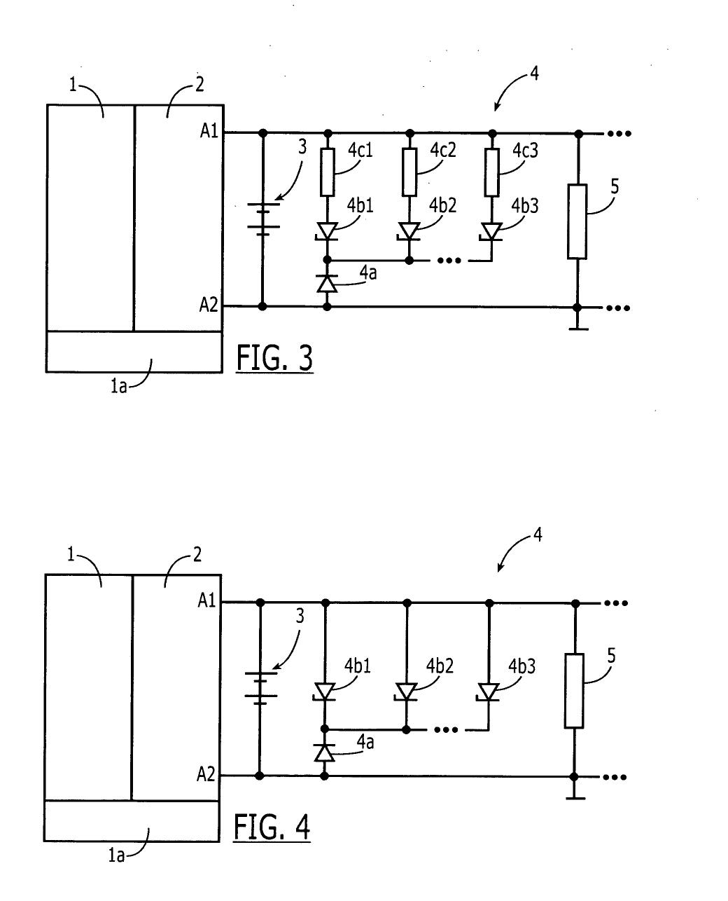

FIG. 3 shows a third exemplary embodiment of a vehicle electrical system according to the present invention. The difference between this third exemplary embodiment and the first exemplary embodiment shown in FIG. 1 is a modified design of reverse polarization detector 4. According to the third exemplary embodiment, it includes a series circuit made up of a parallel connection and a diode 4a. The parallel connection has n parallel branches, with n=3 in the illustrated exemplary embodiment. The first branch of this parallel connection includes a series circuit made up of a threshold-value element 4b1 and a verification element 4c1, threshold-value element 4b1 preferably being a Zener diode. The second branch of this parallel connection includes a series circuit made up of a threshold-value element 4b2 and a verification element 4c2, threshold-value element 4b2 preferably being a Zener diode. The third branch of this parallel connection includes a series circuit made up of a threshold-value element 4b3 and a verification element 4c3, threshold-value element 4b3 preferably being a Zener diode. The Zener voltages of Zener diodes 4b1, 4b2, and 4b3 are differently dimensioned, so that the various branches of the parallel connections have different trigger threshold values.

If the battery has been connected with reverse polarization, then the existing negative voltage and the energy content are so high that the verification elements of all branches respond. This state is stored irreversibly, so that it may be used as later proof of a reverse polarization. Diode 4a remains intact.

However, if negative voltages of lower amplitude and smaller energy content occur that are not attributable to a reverse polarization, this, for instance, may cause one or two of the verification elements to trigger, but not the other verification elements. This triggering of only one or two of the three verification elements is likewise stored in an irreversible manner and thus available for subsequent proof. This allows conclusions as to the level of the negative voltage and thus possibly the cause of the interference that occurred.

In this exemplary embodiment, as well, verification elements 4c1, 4c2 and 4c3 are advantageously designed in such a way that each has a filter function. For example, they may have specified current carrying capabilities. Due to this special design of the verification elements, only negative voltages that have a specified minimum energy content lead to triggering of the particular verification element.

FIG. 4 shows a fourth exemplary embodiment of a vehicle electrical system according to the present invention. The difference between this fourth exemplary embodiment and the second exemplary embodiment shown in FIG. 2 is a modified design of reverse polarization detector 4. According to the fourth exemplary embodiment, it has a series circuit made up of a parallel connection and a diode 4a. The parallel connection has n parallel branches, with n=3 in the illustrated exemplary embodiment. Each of the three parallel branches has a threshold element, which is a Zener diode in the exemplary embodiment shown. A Zener diode 4b1 is provided in the first branch, for instance, a Zener diode 4b2 is provided in the second branch, and a Zener diode 4b3 is provided in the third branch. The Zener voltages of these Zener diodes are dimensioned differently so that different trigger threshold values exist in the various branches of the parallel connection.

If the battery has been connected with reverse polarization, then the existing negative voltage and the energy content are so high that the Zener diodes used as verification elements are destroyed in all branches. This state remains stored irreversibly, so that it may later be used as proof of a reverse polarization. Diode 4a remains intact.

The mentioned Zener diodes are designed such that they also have a filter function. They may have specified current carrying capabilities, for example. Due to this special design of the Zener diodes, only negative voltages having a specified minimum amplitude and a specified minimum energy content will cause triggering or destruction of the particular Zener diode.

If lower negative voltages or voltages having a lower energy content arise that are not attributable to a reverse polarization, then this may cause one Zener diode or two of the Zener diodes to be destroyed and the other Zener diode(s) to remain intact. This destruction of only one or two of the Zener diodes likewise remains stored irreversibly and is available for subsequent proof. In this way, the level of the negative voltage and thus possibly the cause of the occurred interference may be inferred.

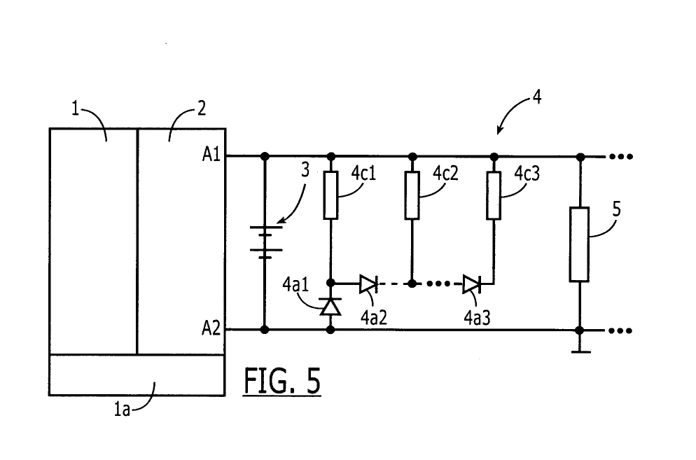

FIG. 5 shows a fifth exemplary embodiment of a vehicle electrical system according to the present invention. The difference between this fifth exemplary embodiment and the exemplary embodiments shown in FIGS. 1-4 is a modified design of reverse polarization detector 4. According to the fifth exemplary embodiment, it has diodes 4a1, 4a2, and 4a3 and also verification elements 4c1, 4c2, and 4c3. The anode of diode 4a1 is connected to output A2 of rectifier 2 and thus to ground as well. The cathode of diode 4a1 is connected to output A1 of rectifier 2 via verification element 4c1, and is also connected to the anode of diode 4a2. The cathode of diode 4a2 is connected to output A1 of rectifier 2 via verification element 4c2, and is in contact with the anode of diode 4a3 as well. The cathode of diode 4a3 is connected to output A1 of rectifier 2 via verification element 4c3.

During proper operation of the illustrated vehicle electrical system, diodes 4a1, 4a2, and 4a3 prevent a current flow through reverse polarization detector 4 since they are connected in reverse direction. If a reverse connection has taken place, however, then one, several or all verification element(s) trigger as a function of the level of the negative voltage. The number of triggered verification elements may subsequently be used to prove the negative voltage level. The elements of reverse polarization detector 4 are designed in such a way that in the event of a reverse polarization it is always the particular verification element that responds, and no destruction of the diodes takes place. In this exemplary embodiment, as well, the verification elements are designed to have a filter function. The verification elements may have a specified current carrying capacity, for instance. Due to this special design of the verification elements, the reverse polarization detector does not trigger in response to any random interruption, but only if the arising energy exceeds a predefined threshold.

In the afore-described exemplary embodiments, the reverse polarization detector is always positioned between battery 3 and loads 5 in the form of a stand-alone component. One alternative specific embodiments consists of realizing generator controller 1a as ASIC, and of integrating reverse polarization detector in this ASIC.

What is claimed is:

1. A vehicle electrical system, comprising:
an alternator;
a rectifier connected to the alternator;
a battery connected to output connections of the rectifier; and
a reverse polarization detector connected to the battery, the detector including a diode and a threshold-value element connected in series with the diode.

2. The vehicle electrical system according to claim 1, wherein the threshold-value element is a Zener diode.

3. The vehicle electrical system according to claim 2, wherein the Zener diode and the diode are dimensioned such that the Zener diode is destroyed in the event of a reverse polarization, while the diode remains intact.

4. The vehicle electrical system according to claim 1, wherein the threshold-value element includes a plurality of Zener diodes connected in parallel, the Zener diodes having different Zener voltages.

5. The vehicle electrical system according to claim 4, wherein the Zener diodes and the diode are dimensioned such that the Zener diodes are destroyed in the event of a reverse polarization, while the diode remains intact.

6. The vehicle electrical system according to claim 1, wherein the threshold-value element has a filter function.

7. The vehicle electrical system according to claim 1, further comprising a verification element connected in series with the threshold-value element.

8. The vehicle electrical system according to claim 7, wherein the verification element has a filter function.

9. The vehicle electrical system according to claim 7, wherein the threshold-value element is a Zener diode.

10. The vehicle electrical system according to claim 9, wherein the diode, the Zener diode, and the verification element are dimensioned such that the verification element responds in the event of a reverse polarization, and the diode and the Zener diode remain intact.

11. The vehicle electrical system according to claim 7, wherein the verification element includes a fuse, a bonding wire, a diode, a chemical indicator element, an optical indicator element, a circuit trace, a pyrotechnical element, or a thermal element.

12. The vehicle electrical system according to claim 7, wherein the reverse polarization detector includes a series circuit made up of the diode and a parallel connection, the parallel connection has a plurality of branches each of which is made up of a series circuit of a threshold-value element and a verification element, the threshold-value elements are Zener diodes, the Zener diodes have different Zener voltages, and each verification element has a filter function.

13. The vehicle electrical system according to claim 1, wherein the reverse polarization detector is part of a generator controller.
